(19) United States
(12) Patent Application Publication
(10) Pub. No.: US 2007/0067720 A1
(43) Pub. Date: Mar. 22, 2007

(54) Method and apparatus for entering Vietnamese words containing characters with diacritical marks in an electronic device having a monitor/display and a keyboard/keypad

(75) Inventor: Phuoc Vinh Tran, San Jose, CA (US)

Correspondence Address: Phuoc Vinh Tran, 1545 Prosperity Ct, San Jose, CA, 95131, US

(73) Assignee: XMLUNIFY, San Jose, CA (US)

(21) Appl. No.: 11/162,668

(22) Filed: Sep. 19, 2005

(51) Int. Cl. G06F 17/00

(52) U.S. Cl. 715/532; 715/535

(57) ABSTRACT

A method of replacing a typing word with unmarked vowels with Vietnamese words containing diacritically marked characters when entering Vietnamese text in a Desktop/Notebook PC or the like. After an unmarked word is entered and displayed on a display device, the numbered list of possibly matched Vietnamese words with diacritical marks is then displayed in a pop-up window, typically immediately under/above and to the left/right of the caret or at the lower right-hand corner of the screen. The numeric keys on the keyboard/keypad can be used to choose a Vietnamese word from the list for replacing the typing unmarked word with the one chosen.

### BACKGROUND OF THE INVENTION

Vietnamese language is a tonal language, written from left to right and based on Latin script although it contains characters with diacritical marks. In Vietnamese, characters can appear either in upper and lower case as in English language.

In the Vietnamese alphabet, there are seventeen consonants available in either upper or lower case, resulting in thirty-four consonants as shown in FIG. 1. Thirty-two out of these thirty-four consonants (except for d and D with stroke) can be entered with the regular English keyboard/keypad (like 101 key US keyboard).

In addition, there are seventy-two unique vowels with diacritical marks in either upper or lower case, resulting in 144 vowels as shown in FIG. 2. Unlike the consonants, only twelve out of these 144 vowels can be entered with the regular English keyboard/keypad (like 101 key US keyboard).

Due to the lack of keys for entering the other two consonants (d and D with stroke) and 132 vowels that are unique to Vietnamese language, it is advantageous and desirable to provide a method and apparatus for entering Vietnamese words containing characters with diacritical marks in an electronic device having a monitor/display and using the currently available keys on the regular English keyboard/keypad (like 101 key US keyboard).

### SUMMARY OF THE INVENTION

It is a primary object of the present invention to provide a method for entering Vietnamese words containing the Vietnamese specific consonants (d and D with stroke) and vowels with diacritical marks in an electronic device having a monitor/display and a keyboard/keypad (or onscreen keyboard/keypad). This object can be achieved by automatically display a numbered list of possibly matched Vietnamese words containing the Vietnamese specific consonants (d and D with stroke) and vowels with diacritical marks based on the typing word entered with the regular English keyboard/keypad (like 101 key US keyboard as shown in FIG. 3).

The numbered list of possibly matched Vietnamese words containing the Vietnamese specific consonants (d and D with stroke) and vowels with diacritical marks is typically displayed in a pop-up window in a non-intrusive manner, such as immediately under/above and to the left/right of the caret or at the lower right-hand corner of screen. The end user may choose a Vietnamese word containing the Vietnamese specific consonants (d and D with stroke) and vowels with diacritical marks from the list by entering the number in front of the word. The typing word entered with the regular English keyboard/keypad is replaced with the Vietnamese word containing the Vietnamese specific consonants (d and D with stroke) and vowels with diacritical marks that the user has chosen.

### BRIEF DESCRIPTION OF THE DRAWINGS

FIG. 1 is a picture showing the thirty-four Vietnamese consonants including d and D with stroke.

FIG. 2 is a picture showing the 1 44 Vietnamese vowels with diacritical marks.

FIG. 3 is a picture showing the typical layout of 101 key US keyboard.

FIG. 4a illustrates the upper case consonant—V being entered and displayed in the Notepad text editor.

FIG. 4b illustrates the lower case vowel—i being entered and displayed in the Notepad text editor.

FIG. 4c illustrates the lower case vowel—e being entered and displayed in the Notepad text editor.

FIG. 4d illustrates the lower case consonant—t being entered and displayed in the Notepad text editor.

FIG. 4e illustrates the unmarked word—Viet being replaced with the Vietnamese word with proper diacritical marks from the numbered list in the pop-up window (Those two Vietnamese words mean Vietnamese language).

FIG. 5 is a picture showing all electronic devices in various sizes having a CRT monitor/LCD display and a keyboard/keypad (either actual or onscreen) for entering alphabetic characters and numerals.

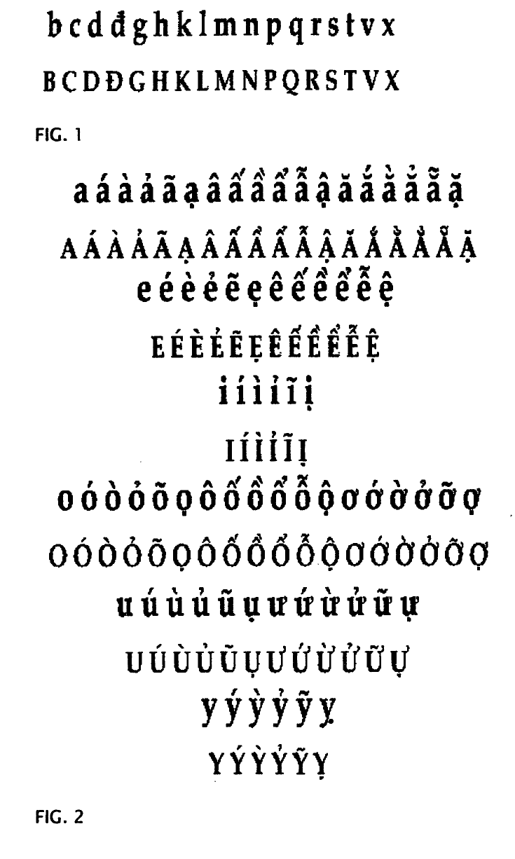

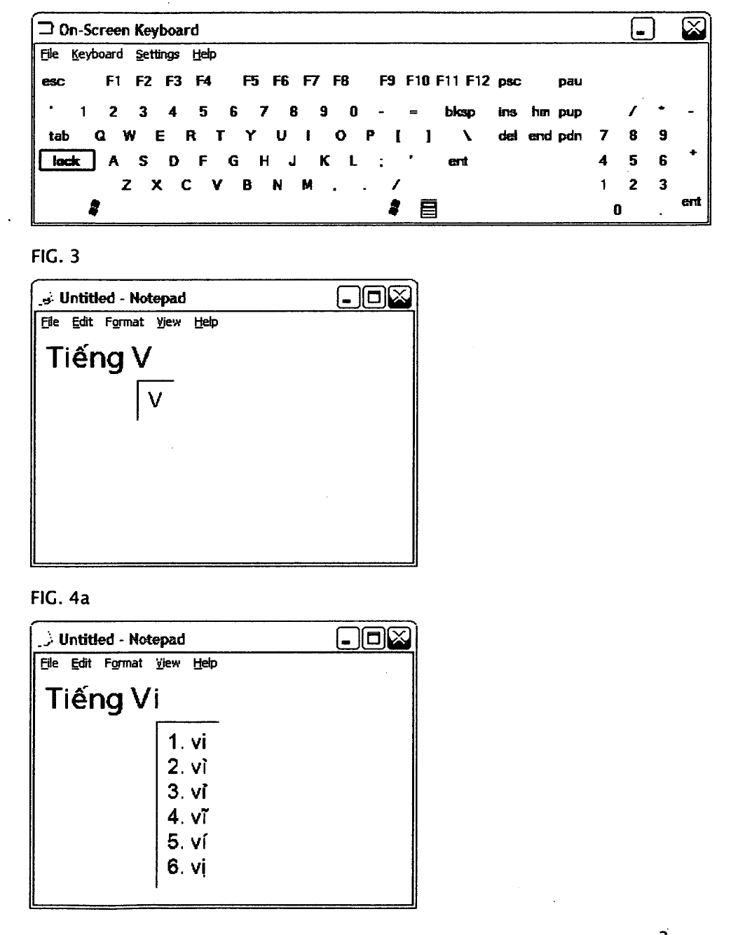

### DETAILED DESCRIPTION OF THE INVENTION

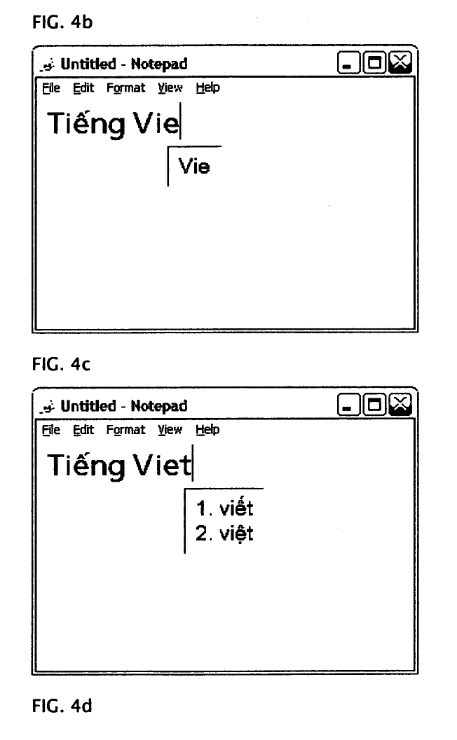

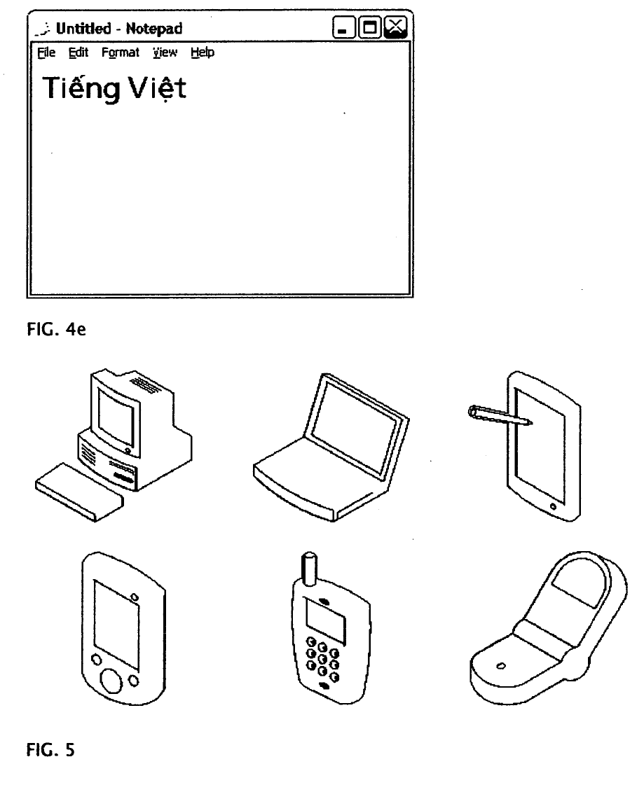

In the preferred embodiment of the present invention, as shown in FIG. 4e, the Vietnamese word—Viet (contains the vowel—e with the combination of diacritic—circumflex and tone mark—dot below) is entered in the Notepad text editor on a Notebook PC running Microsoft Windows XP. As shown in FIG. 4a, the upper case consonant—V is entered in the Notepad text editor. Next, the lower case vowel—i is entered as shown in FIG. 4b. Next, the lower case vowel—e is entered as shown in FIG. 4c. Next, the lower case consonant—t is entered as shown in FIG. 4d. Now there are two possibly matched Vietnamese words with proper diacritic marks displayed in the pop-up window. Finally, once the number 2 is entered for selecting the second word in the numbered list, the Vietnamese word containing the vowels with proper diacritical marks replaces the typing word containing unmarked vowels as shown in FIG. 4e.

It should be noted that the present invention has been described mainly in conjunction with a Notebook PC having a LCD display and alphanumeric keyboard for entering alphabetic characters and numerals (like 101 key US keyboard). The present invention, in general, is applicable to all electronic devices in various sizes having a CRT monitor/LCD display and a keyboard/keypad (either actual or onscreen) for entering alphabetic characters and numerals. Any of these electronic devices can be a Desktop PC, Notebook PC, Pocket PC, Tablet PC, a mobile phone, Media Center PC and the like as shown in FIG. 5.

Thus, although the invention has been described with respect to a preferred embodiment thereof, it will be understood by those skilled in the art that the foregoing and various other changes, omissions and deviations in the form and detail thereof may be made without departing from the spirit and scope of this invention.

What is claimed is:

1. A method of monitoring a typing word with unmarked characters when entering Vietnamese text in an electronic device. After an unmarked word is entered and displayed on a monitor/display, the numbered list of possibly matched Vietnamese words with diacritical marks is then displayed in a pop-up window, typically immediately under/above and to the left/right of the caret or at the lower right-hand corner of the screen.

2. The method of claim 1, wherein the electronic device comprises a Desktop PC.

3. The method of claim 1, wherein the electronic device comprises a Notebook PC.

4. The method of claim 1, wherein the electronic device comprises a Pocket PC.

5. The method of claim 1, wherein the electronic device comprises a Tablet PC.

6. The method of claim 1, wherein the electronic device comprises a mobile phone.

7. The method of claim 1, wherein the electronic device comprises a Media Center PC.

8. A method of processing the numerical selection of Vietnamese word when entering Vietnamese text in an electronic device. The numeric keys on the keyboard/keypad can be used to choose a Vietnamese word from the numbered list of possibly matched Vietnamese words with diacritical marks displayed in a pop-up window, typically immediately under/above and to the left/right of the caret or at the lower right-hand corner of the screen.

9. The method of claim 8, wherein the electronic device comprises a Desktop PC.

10. The method of claim 8, wherein the electronic device comprises a Notebook PC.

11. The method of claim 8, wherein the electronic device comprises a Pocket PC.

12. The method of claim 8, wherein the electronic device comprises a Tablet PC.

13. The method of claim 8, wherein the electronic device comprises a mobile phone.

14. The method of claim 8, wherein the electronic device comprises a Media Center PC.

15. A method of replacing a typing word with unmarked characters with Vietnamese words containing diacritically marked characters when entering Vietnamese text in an electronic device. After an unmarked word is entered and displayed on a monitor/display, the numbered list of Vietnamese words with diacritical marks is then displayed in a pop-up window, typically immediately under/above and to the left/right of the caret or at the lower right-hand corner of the screen. The numeric keys on the keyboard/keypad can be used to choose a Vietnamese word from the list for replacing the typing unmarked word with the one chosen.

16. The method of claim 15, wherein the electronic device comprises a Desktop PC.

17. The method of claim 15, wherein the electronic device comprises a Notebook PC.

18. The method of claim 15, wherein the electronic device comprises a Pocket PC.

19. The method of claim 15, wherein the electronic device comprises a Tablet PC.

20. The method of claim 15, wherein the electronic device comprises a mobile phone.

21. The method of claim 1 5, wherein the electronic device comprises a Media Center PC.
